(19) United States
(12) Patent Application Publication
(10) Pub. No.: US 2010/0125696 A1
(43) Pub. Date: May 20, 2010

(54) Memory Controller For Controlling The Wear In A Non-volatile Memory Device And A Method Of Operation Therefor

(76) Inventors: Prasanth Kumar, Fremont, CA (US); Dongsheng Xing, Fremont, CA (US); Fong-Long Lin, Fremont, CA (US)

Correspondence Address: DLA PIPER LLP (US ), 2000 UNIVERSITY AVENUE, EAST PALO ALTO, CA, 94303-2248, US

(21) Appl. No.: 12/272,693

(22) Filed: Nov. 17, 2008

(51) Int. Cl. G06F 12/02; G06F 12/00

(52) U.S. Cl. 711/103; 711/E12.008

(57) ABSTRACT

A memory controller controls the operation of a non-volatile memory device. The memory device has a data storage section and an erased storage section. The data storage section has a first plurality of blocks and the erased storage section has a second plurality of blocks. Each of the first and second plurality of blocks has a plurality of non-volatile memory bits that are erased together. Further, each block has an associated counter for storing the number of times the block has been erased. The memory controller has program instructions which are to scan the counters associated with the blocks of the first plurality of blocks based upon the count contained in each of the counters associated therewith to select a third block, and to scan the counters associated with the blocks of the second plurality of blocks based upon the count contained in each of the counters associated therewith to select a fourth block. The program instructions are further configured to transfer data from the third block to the fourth block, and associating said fourth block with said first plurality of blocks. Finally the program instructions are configured to erase said third block and incrementing the counter associated with said third block, and associating said third block with said second plurality of blocks. The present invention is also a method of operating a non-volatile memory device in accordance with the above described steps.

### TECHNICAL FIELD

The present invention relates to a method of leveling the amount of static wear in a nonvolatile memory device. The present invention also relates to a memory controller for operating the non-volatile memory device in accordance with the method.

### BACKGROUND OF THE INVENTION

Nonvolatile memory devices having an array of non-volatile memory cells are well known in the art. Non-volatile memories can be of NOR type or NAND type. In certain types of non-volatile memories, the memory is characterized by having a plurality of blocks, with each block having a plurality of bits, with all of the bits in a block being erasable at the same time. Hence, these are called flash memories, because all of the bits or cells in the same block are erased together. After the block is erased, the cells within the block can be programmed by certain size (such as byte) as in the case of NOR memory, or a page is programmed at once as in the case of NAND memories.

Referring to FIG. 1 there is shown a memory controller 10 of the prior art. The memory controller 10 has a NOR memory 12 which stores program instructions for execution by the controller 10 for operating a NAND memory device 20, which is connected to the controller 10. The controller 10 is also connected to a host device 30 in which the user or the host device 30 can supply the controller 10 with address signals, data signals and control signals, to operate the NAND memory device 20 by the controller 10. Although the controller 10 shown in FIG. 1 is shown as controlling a NAND memory device 20, it should be clear to those skilled in the art that the controller 10 can also control a NOR type of memory device or any other type of non-volatile memory device having the characteristics which will be described hereinbelow. Further, although the NAND controller 10 is shown is being “separate” from the NAND memory device 20, it should be clear that this is for illustration purpose only, and that the controller 10 and the memory device 20 may be integrated in the same integrated circuit to form a single unitary device. Therefore, as described hereinbelow, the operation of the controller 10 is deemed to be an internal operation of the memory device 20.

As is well known, the address signals supplied by the host device 30 to the controller 10 is in the nature of logical address, and that the controller 10 must translate that logical address into a physical address. Further, the NAND memory device 20 is characterized by having a plurality of blocks, with each block comprising a plurality of bits or memory cells, which are erased together. Thus, in an erase operation the memory cells of an entire block are erased together. As discussed above, such feature is common to all flash memory devices, wherein all memory cells in a block are erased in a “flash”.

One of the problems of flash non-volatile memory devices is that there is a finite amount by which a block can be erased before problems, such as data retention, occur. Thus, it is desired to even out the “wear” or the number of cycles by which each block is erased. Hence, there is a desire to level the wear of blocks in a flash memory device.

Referring to FIG. 2 there is shown a schematic diagram of one method of the prior art in which wear leveling is accomplished. As previously discussed, associated with each block is a physical address, which is mapped to a user logical address. The memory device 20 has a first plurality of blocks that are used to store data (designated as user logical blocks 0-977, with the associated physical blocks address designated as 200, 500, 501, 502, 508, 801 etc. through 100). The memory device 20 also comprises a second plurality of blocks that comprise spare blocks, bad blocks and overhead blocks. These are erased blocks and other blocks that do not store data. In the first embodiment of the prior art for leveling the wear on a block of non-volatile memory cells, when a certain block, such as user block 2, having a physical address of 501 (hereinafter all blocks shall be referred to by their physical address) is updated, new data or some old data in block 501 is moved to an erased block. A block from the Erased Pool, such as block 800, is chosen and the new data or some old data from block 501 is written into that block. In the example shown in FIG. 2, this is physical block 800, which is used to store new data. Physical block 800 is then associated with logical block 2 in the first plurality of blocks. Thereafter, block 501 is erased, and is then “moved” to be associated with the second plurality of erased blocks (hereinafter: “Erased Pool”). The “movement” of the physical block 501 from the first plurality of blocks (the stored data blocks) to the Erased Pool occurs by simply updating the table associating the user logical address block with the physical address block. Schematically, this is shown as the physical address block 501 is “moved” to the Erased Pool. When physical block 501 is returned to the Erased Pool, it is returned in a FIFO (First In First Out) manner. Thus, physical block 501 is the last block returned to the Erased Pool. Thereafter as additional erased blocks are returned to the Erased Pool, physical block pool is “pushed” to the top of the stack.

Referring to FIG. 3, there is shown a schematic diagram of another method of the prior art to level the wearing of blocks in a flash memory device. Specifically, associated with each of the physical blocks in the plurality of erased blocks is a counter counting the number of times that block has been erased. Thus, as the physical block 501 is erased, its associated erase counter is incremented. Within the second plurality of blocks, the blocks in the Erased Pool are arranged in a manner depending on the count in the erase counter associated with each physical block. The physical block having the youngest count, or the lowest count in the erase counter is poised to be the first to be returned to the first plurality of blocks to be used to store data. In particular, as shown in FIG. 3, for example, physical block 800 is shown as the “youngest” block, meaning that physical block 800 has the lowest count associated with the erased blocks in the Erased Pool. Physical block 501 from the first plurality is erased, its associated erase counter is incremented, and the physical block 501 is then placed among the second plurality of blocks (and if the erased block is able to retain data, it is returned to the Erased Pool). The erased block is placed in the Erased Pool depending upon the count in the erase counter associated with each of the blocks in the Erased Pool. As shown in FIG. 3, by way of example, the erase counter in physical block 501 after incrementing may have a count that places the physical block 501 between physical block 302 and physical block 303. Physical block 501 is then placed at that location.

The above described methods are called dynamic wear-leveling methods, in that wear level is considered only when data in a block is updated, i.e. the block would have had to be erased in any event. However, the dynamic wear-leveling method does not operate if there is no data update to a block. The problem with dynamic wear-leveling method is that for blocks that do not have data that is updated, such as those blocks storing operating system data or other types of data that is not updated or is updated infrequently, the wear level technique does not serve to cause the leveling of the wear for these blocks with all other blocks that have had more frequent changes in data. Thus, for example, if physical blocks 200 and 500 store operating system data, and are not updated at all or are updated infrequently, those physical blocks may have very little wear, in contrast to blocks such as physical block 501 (as well as all of the other blocks in the first plurality of blocks) that might have had greater wear. This large difference between physical blocks 501 and physical blocks 200 and 500, for example, may result in a lower over all usage of all the physical blocks of the NAND memory 20.

### SUMMARY OF THE INVENTION

A memory controller controls the operation of a non-volatile memory device. The memory device has a data storage section and an erased storage section. The data storage section has a first plurality of blocks and the erased storage section has a second plurality of blocks. Each of the first and second plurality of blocks has a plurality of non-volatile memory bits that are erased together. Further, each block has an associated counter for storing a count of the number of times the block has been erased. The memory controller has program instructions which are to determine the count in the counters associated with the blocks of the first plurality of blocks to select a third block, and to determine the count in the counters associated with the blocks of the second plurality of blocks to select a fourth block. The program instructions are further configured to transfer data from the third block to the fourth block, and associating said fourth block with said first plurality of blocks. Finally the program instructions are configured to erase said third block and incrementing the counter associated with said third block, and associating said third block with said second plurality of blocks.

The present invention is also a method of operating a non-volatile memory device in accordance with the above described steps.

### BRIEF DESCRIPTION OF THE DRAWINGS

FIG. 1 is a schematic block diagram of a memory controller of the prior art in which the method of the present invention, embodied as program instructions can operate.

FIG. 2 is a schematic diagram of a first embodiment of a prior art method of operating a non-volatile memory device.

FIG. 3 is a schematic diagram of a second embodiment of a prior art method of operating a non-volatile memory device.

FIG. 4 is a schematic diagram of the method of the present invention of operating a non-volatile memory device.

### DETAILED DESCRIPTION OF THE INVENTION

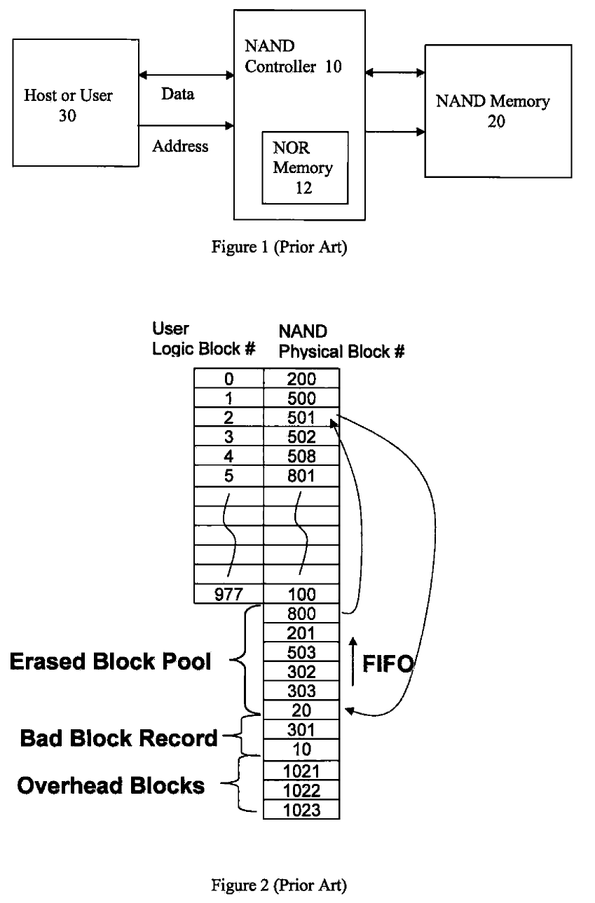

The present invention relates to a memory controller 10 of the type shown in FIG. 1 for controlling a Flash non-volatile memory 20 (for example a NAND flash memory 20). The controller 10 also contains a NOR memory 12 which stores program instructions for execution by the processor (not shown) contained in the NAND controller 10. The program instructions causes the processor and the NAND controller 10 to control the operation of the NAND memory 20 in the manner described hereinafter. The present invention also relates to the method of controlling the flash NAND memory 20.

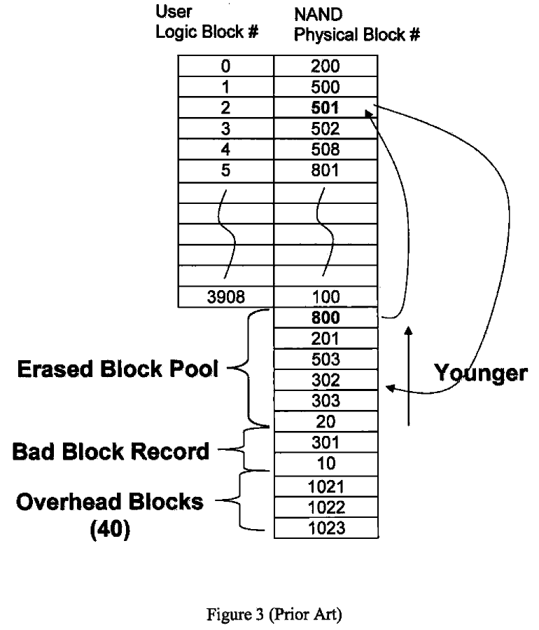

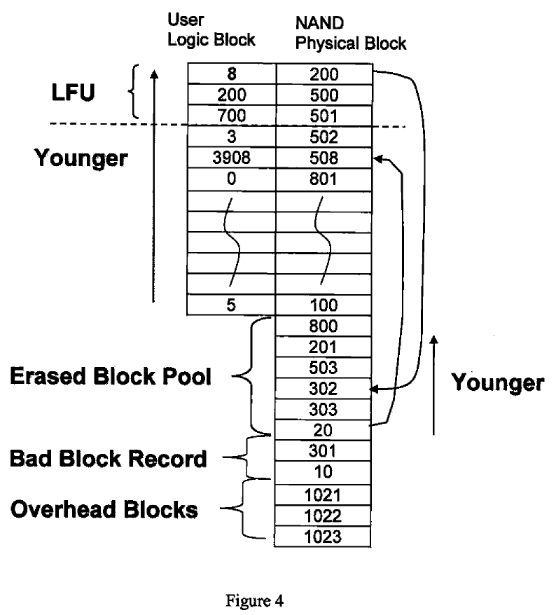

Referring to FIG. 4 there is shown a schematic diagram of the method of the present invention. Similar to the method shown and described above for the embodiment shown in FIG. 3, the NAND memory device 20 is characterized by having a plurality of blocks, with each block comprising a plurality of bits or memory cells, which are erased together. Thus, in an erase operation the memory cells of an entire block are erased together.

Further, associated with each block is a physical address, which is mapped to a user logical address, by a table, called a Mapping Table, which is well known in the art. The memory device 20 has a first plurality of blocks that are used to store data (designated as user logical blocks, such as 8, 200, 700, 3, 3908 and 0, each with its associated physical blocks address designated as 200, 500, 501, 502, 508, 801 etc.). The memory device 20 also comprises a second plurality of blocks that comprise spare blocks, bad blocks and overhead blocks. The spare blocks are erased blocks and form the Erased Pool and other blocks that do not store data. Further, each of the physical blocks in the Erased Pool has a counter counting the number of times that block has been erased. Thus, as the physical block 200 is erased, its associated erase counter is incremented. The blocks in the Erased Pool are candidates for swapping. The erase operation can occur before a block is placed into the Erased Pool or immediately before it is used and moved out of the Erased Pool. In the latter event, the blocks in the Erased Pool may not all be erased blocks.

As previously described in the background of the invention, when a certain block, such as user block 8, having a physical address of 200 (hereinafter all blocks shall be referred to by their physical address) is updated, some of the data from that block along with new data may need to be written to a block from the Erased Pool. Thereafter, block 200 must be erased and is then “moved” to be associated with the Erased Pool (if the erased block can still retain data. Otherwise, the erased block is “moved” to the blocks that are deemed “Bad Blocks”).

The “movement” of the physical block 200 from the first plurality of blocks (the stored data blocks) to the second plurality of blocks (the Erased Pool or the Bad Blocks) occurs by simply updating the Mapping Table. Schematically, this is shown as the physical address block 200 is “moved” to the Erased Pool.

In the present invention, however, the wear-level method may be applied even if there is no update to any data in any of the blocks from the first plurality of blocks. This is called static wear leveling. Specifically, within the first plurality of blocks, a determination is first made as to the Least Frequently Used (LFU) blocks, i.e. those blocks having the lowest erase count stored in the erase counter. The LFU log may contain a limited number of blocks, such as 16 blocks, in the preferred embodiment. Thus, as shown in FIG. 4, the LFU comprises physical blocks 200, 500 and 501, with block 200 having the lowest count in the erase counter.

Thereafter, the block with the lowest count in the erase counter within the LFU, such as physical block 200, is erased (even if there is no data to be updated to the physical block 200). The erased physical block 200 is then “moved” to the second plurality of blocks, i.e. either the Erased Pool or the Bad Blocks.

The plurality of erased blocks in the Erased Pool is also arranged in an order ranging from the “youngest”, i.e. the block with the count in the erase counter being the lowest, to the “oldest”, i.e. the block with the count in the erase counter being the highest. The block which is erased from the first plurality and whose erase counter is incremented has its count in the erase counter compared to the erase counter of all the other blocks in the Erased Pool and arranged accordingly. The arrangement need not be in a physical order. The arrangement, e.g. can be done by a link list or a table list or any other means.

The block with the highest erase count, or the “oldest” block (such as physical block 20) from the erased Pool is then used to store data retrieved from the “youngest” block (physical block 200) from the LFU in the first plurality of blocks. Physical block 20 is then returned to the first plurality of blocks.

Based upon the foregoing description, it can been that with the static wear level method of the present invention, blocks in the first plurality which are not updated or are infrequently updated, will be “recycled” into the Erased Pool and re-used, thereby causing the wear to be leveled among all of the blocks in the NAND memory 20. It should be noted that in the method of the present invention, when the “youngest” block among the LFU is returned to the Erased Pool, the “oldest” block from the Erased Pool is used to replace the “youngest” block from the LFU. This may seem contradictory in that the “youngest” from LFU may then reside in the Erased Pool without ever being subsequently re-used. However, this is only with regard to the static wear level method of the present invention. It is contemplated that as additional data is to be stored in the NAND memory 20 and a new erased block is requested, that the “youngest” erased block from the Erased Pool is then used to store the new or additional data. Further, the “youngest” block from the Erased Pool is also used in the dynamic wear level method of the prior art. Thus, the blocks from the Erased Pool will all be eventually used. Furthermore, because the static wear level method of the present invention operates when data to a block is not being replaced, there are additional considerations, such as frequency of operation (so as not to cause undue wear) as well as resource allocation. These issues are discussed hereinafter.

At the outset, the issue is when are the blocks within the first plurality of blocks scanned to create the LFU, which is used in the subsequent static wear level method of the present invention. There are a number of ways this can be done. What follows are various possible techniques, that are illustrative and not meant to be exhaustive. Further, some of these methods may be collectively used together.

First, the controller 10 can scan the first plurality of blocks when the NAND memory 20 is first powered up.

Second, the controller 10 can scan the first plurality of blocks when the host 30 issues a specific command to scan the first plurality of blocks in the NAND memory 20. As a corollary to this method, the controller 10 can scan the first plurality of blocks when the host 30 issues a READ or WRITE command to read or write certain blocks in the NAND memory 20. Thereafter, the controller 10 can continue to read all of the rest of the erase counters within the first plurality of blocks. In addition, the controller 10 may limit the amount of time to a pre-defined period by which scanning would occur after a READ or WRITE command is received from the host 30.

Third, the controller 10 can scan the first plurality of blocks in the background. This can be initiated, for example, when there has not been any pending host command for a certain period of time, such as 5 m sec, and can be stopped when the host initiates a command to which the controller 10 must respond.

Fourth, the controller 10 can initiate a scan after a predetermined event, such as after a number of ATA commands is received by the controller 10 from the host 30.

Once it is determined when the erase counters for each of the blocks in the first plurality of blocks is scanned to create the LFU, the next determining element is the methodology by which the erase counters of the first plurality of blocks are scanned. Again, there are a number of methods, and what is described hereinbelow is illustrative only and is by no means exhaustive.

First, the controller 10 can scan all of the blocks in the first plurality of blocks in a linear manner starting from the first entry in the Mapping Table, until the last entry.

Second, the controller 10 can scan the blocks in the first plurality of blocks based upon a command from the host 30. Fort example, if the host 30 knows where data, such as operating system programs, are stored and thus which blocks are more probable of containing the “youngest” blocks, then the host 30 can initiate the scan at certain logical address or to indicate the addresses where scanning should be limited.

Third, the controller 10 can also scan all the blocks of the first plurality of blocks in a random manner. The processor in the controller 10 can include a random number generator which generates random numbers that can be used to correlate to the physical addresses of the blocks.

Fourth, the controller 10 can also scan all the blocks of the first plurality of blocks in a pseudo random manner. The processor in the controller 10 can include a pseudo random number generator (such as a prime number generator) which generates pseudo random numbers that can be used to correlate to the physical addresses of the blocks.

Once the LFU is created, then the method of the present invention can be practiced. However, since the static wear level method of the present invention does not depend on the updating of data in a block, the issue becomes when does the exchange of data between the “youngest” block in the LFU and that of the “oldest” block in the Erased Pool occur. There are a number of ways this can be done. Again, what follows are various possible techniques, and is illustrative and not meant to be exhaustive.

First, the controller 10 can exchange a limited number of blocks, such as sixteen (16), when the NAND memory 20 is first powered up.

Second, the controller 10 can exchange a number of blocks in response to the host 30 issuing a specific command to exchange the number of blocks. As a corollary to this method, the controller 10 can also exchange a limited number of blocks, such as one (1), after the host 30 issues a READ or WRITE command to read or write certain blocks in the NAND memory 20. Thereafter, the controller 10 can exchange one block.

Third, the controller 10 can exchange a limited number of blocks, such as sixteen (16), in the background. This can be initiated, for example, when there has not been any pending host command for a certain period of time, such as 5 m sec, and can be stopped when the host initiates a command to which the controller 10 must respond.

Fourth, the controller 10 can exchange a limited number of blocks, such as one (1) after a predetermined event, such as after a number of ATA commands is received by the controller 10 from the host 30.

It should be clear that although the method of the present invention levels the wear among all of the blocks in the NAND memory 20, the continued exchange of data from one block in the LFU to another block in the Erased Pool can cause excessive wear. There are a number of methods to prevent unnecessary exchanges. Again, what follows are various possible techniques, and is illustrative and not meant to be exhaustive. Further, the methods described herein may be collectively implemented.

First, a determination can be made between the count in the erase counter of the “youngest” in the LFU and the “oldest” in the blocks of the Erased Pool. If the difference is within a certain range, the exchange between the “youngest” in the LFU and the “oldest” block in the Erased Pool would not occur. The difference between the count in the erase counter of the “youngest” in the LFU and the “oldest” block in the Erased Pool can also be stored in a separate counter.

Second, the controller 10 can maintain two counters: one for storing the number of host initiated erase counts, and another for storing the number of erase counts due to static wear level method of the present invention. In the event, the difference between the two values in the two counters is less than a pre-defined number, then the static wear level method of the present invention would not occur. The number of host initiated erase counts would include all of the erase counts cause by dynamic wear level, i.e. when data in any block is updated, and any other events, that causes an erase operation to occur.

Third, the controller 10 can set a flag associated with each block. As each block is exchanged from the Erased Pool, the flag is set. Once the flag is set, that block is no longer eligible for the wear level method of the present invention until the flags of all the blocks within the first plurality of blocks are set. Thereafter, all of the flags of the blocks are re-set and the blocks are then eligible again for the wear level method of the present invention.

Fourth, a counter is provided with each block in the first plurality of blocks for storing data representing the time when that block was last erased, pursuant to the method of the present invention. In addition, the controller 10 provides a counter for storing the global time for the first plurality of blocks. In the event, a block is selected to have its data to be exchanged with a block from the Erased Pool, the counter storing the time representing when the last erase operation occurred is compared to the global time. In the event the difference is less than a predetermined number, (indicating that the block of interest was recently erased pursuant to the static wear level method of the present invention), then the block is not erased and is not added to the LFU (or if already on the LFU, it is removed therefrom).

As is well known in the art, flash memory, and especially NAND memory 20 is prone to error. Thus, the controller 10 contains error detection and error correction software. Another benefit of the method of the present invention is that, as each block in the LFU is read and then the data is recorded to an erased block from the Erased Pool, the controller 10 can determine to what degree the data from the read block contains errors. If the data read from the read block is data which does not need correction, then the erased block is returned to the Erased Pool. However, if data read from the read block contains correctable error, (and depending upon the degree of correction), the read block may then be returned to the Bad Block pool. In this manner, marginally good blocks can be detected and retired before the data stored therein becomes unreadable.

It should be apparent that there are many benefits of the method and controller of the present invention. By evening the wear among all of the blocks, the overall life usage of the NAND memory 20 is increased, and the reliability improved.

What is claimed is:

1. A method of leveling the amount of wear in a non-volatile memory device having a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing a count of the number of times the block has been erased, wherein the method comprises:
determining from the count in the counters associated with the blocks of the first plurality of blocks to select a third block;
determining from the count in the counters associated with the blocks of the second plurality of blocks to select a fourth block;
transferring data from the third block to the fourth block, and associating said fourth block with said first plurality of blocks; and
erasing said third block and incrementing the counter associated with said third block, and associating said third block with said second plurality of blocks.

2. The method of claim 1 wherein said third block is selected based upon the count being the smallest among the counters associated with the first plurality of blocks.

3. The method of claim 2 wherein said fourth block is selected based upon the count being the largest among the counters associated with the second plurality of blocks.

4. The method of claim 3 wherein said transferring and erasing steps are performed if the difference between the largest and the smallest count in the counters is greater than a pre-set amount.

5. The method of claim 3 wherein said scanning, transferring and erasing steps are not performed if the difference between the largest and the smallest count in the counters is within a pre-determined range.

6. The method of claim 1 wherein said scanning, transferring and erasing steps are performed based upon a command supplied from a source external to the non-volatile memory device.

7. The method of claim 6 wherein said non-volatile memory device further comprising a command counter, wherein said command counter is incremented when a command to transfer and erase is supplied from a source external to the non-volatile memory device.

8. The method of claim 7 wherein said scanning, transferring and erasing steps are also performed based upon a controller in said non-volatile memory device initiating an internal command.

9. The method of claim 8 wherein said non-volatile memory device further comprising an internal command counter, wherein said internal command counter is incremented when an internal command to transfer and erase is received.

10. The method of claim 9 wherein said scanning, transfer and erase steps are not formed in the event the difference between the count in the command counter and the count in the internal command counter is less than a pre-set number.

11. The method of claim 3 wherein each of said blocks of said first plurality has a flag associated therewith.

12. The method of claim 11 wherein the flag of a block is set in the event the block was transferred and erased pursuant to the method of claim 1.

13. The method of claim 12 wherein blocks of said first and second plurality of blocks having the flag set are not subject to the transfer and erase steps of claim 1.

14. The method of claim 13 wherein blocks having the flag set are not subject to the determining step.

15. The method of claim 14 further comprising the step of:
resetting the flags of all the blocks of said first plurality of blocks after all of the flags of said first plurality of blocks have been set.

16. The method of claim 1 wherein a block from the first plurality of blocks is not subject to the steps of transferring and erasing, in the event it was recently modified.

17. The method of claim 16 wherein each block of said first plurality of blocks has a timer counter associated therewith.

18. The method of claim 17 wherein said first plurality of blocks has a global timer counter associated therewith.

19. The method of claim 18 wherein the timer counter associated with a written block is compared to the global timer counter, and the block is not subject to the transferring and erase step in the event the difference between the timer counter associated with a written block and the global timer counter is less than a predetermined amount.

20. The method of claim 1 wherein said non-volatile memory device is a NAND memory device.

21. The method of claim 1 wherein said non-volatile memory device is a NOR memory device,

22. The method of claim 1 wherein said erased storage section comprises erased spare blocks.

23. The method of claim 1 wherein said steps of scanning the counters associated with the blocks of the first plurality of blocks is performed in response to an externally supplied command to the non-volatile memory device to determine.

24. The method of claim 23 wherein said steps of determining from the count in the counters associated with the blocks of the first plurality of blocks and the blocks of the second plurality of blocks is performed in the event no externally supplied command to the non-volatile memory device has been received for a pre-set period of time.

25. The method of claim 1 wherein said steps of determining from the count in the counters associated with the blocks of the first plurality of blocks and the blocks of the second plurality of blocks is performed in response to a power up of the non-volatile memory device.

26. The method of claim 1 wherein said steps of determining from the count in the counters associated with the blocks of the first plurality of blocks and the blocks of the second plurality of blocks is performed in response to an externally supplied command to the non-volatile memory device to read or to write.

27. The method of claim 1 wherein said steps of determining from the count in the counters associated with the blocks of the first plurality of blocks and the blocks of the second plurality of blocks is performed in response to pre-determined events.

28. A memory controller for controlling the operation of a non-volatile memory device having a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing a count of the number of times the block has been erased, wherein the memory controller having program instructions configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the count in the counter associated with said third block, and associating said third block with said second plurality of blocks.

29. The memory controller of claim 28 wherein said program instructions are configured to select the third block based upon the count being the smallest among the counters associated with the first plurality of blocks, and wherein said program instructions are configured to select the fourth block based upon the count being the largest among the counters associated with the second plurality of blocks.

30. The memory controller of claim 29 wherein said program instructions are configured to perform the steps of transfer and erase if the difference between the largest and the smallest count in the counters is greater than a pre-set amount.

31. The memory controller of claim 29 wherein the program instructions are configured to determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks, in response to a first command supplied from a source external to the non-volatile memory device.

32. The memory controller of claim 31 wherein said controller further comprising a command counter, wherein said command counter is incremented when the first command is received.

33. The memory controller of claim 32 wherein the program instructions are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in response to a second command generated internally to the memory controller.

34. The memory controller of claim 33 further comprising an internal command counter, wherein said internal command counter is incremented when the second command is generated.

35. The memory controller of claim 34 wherein the program instructions are configured to
determine from the count in the counters associated with the blocks of the first plurality of blocks to select a third block;
determine from the count in the counters associated with the blocks of the second plurality of blocks to select a fourth block;
transfer data from the third block to the fourth block, and associating said fourth block with said first plurality of blocks; and
erase said third block and incrementing the counter associated with said third block, and associating said third block with said second plurality of blocks,
in the event the difference between the count in the command counter and the count in the internal command counter is greater than a pre-set number.

36. The memory controller of claim 28 wherein the non-volatile memory device controlled by the memory controller is a NAND memory device.

37. A memory controller for controlling the operation of a non-volatile memory device having a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing the number of times the block has been erased, wherein the memory controller having program instructions configured to
transferring data from a first block from the first plurality of blocks, having a lowest value stored in the associated counter to a second block from the second plurality of blocks, having a highest value stored in the associated counter;
associating said second block with said first plurality of blocks;
erasing said first block and incrementing the counter associated with said first block; and
associating said first block with said second plurality of blocks.

38. A method of leveling the amount of wear in a non-volatile memory device having a data storage section and an erased storage section, wherein the data storage section has a first plurality of blocks and the erased storage section has a second plurality of blocks, and wherein each of the first and second plurality of blocks has a plurality of non-volatile memory bits that are erased together, and each block has an associated counter for storing the number of times the block has been erased, wherein the method comprises:
transferring data from a first block from the first plurality of blocks, wherein said first block having a first value stored in its associated counter, with said first value being the lowest value of all values in all of the counters associated with the blocks of said first plurality, to a second block from the second plurality of blocks, wherein said second block having a second value stored in its associated counter, with said second value being the highest value of all values in all of the counters associated with the blocks of said second plurality
associating said second block with said first plurality of blocks;
erasing said first block and incrementing the counter associated with said first block; and
associating said first block with said second plurality of blocks.
